(19) United States
(12) Patent Application Publication
(10) Pub. No.: US 2015/0048287 A1
(43) Pub. Date: Feb. 19, 2015

(54) PANEL LIFTER

(71) Applicant: Stanley Black & Decker, Inc., New Britain, CT (US)

(72) Inventor: Aliaksei Chernyshou, Farmington, CT (US)

(21) Appl. No.: 13/967,576

(22) Filed: Aug. 15, 2013

(51) Int. Cl. B66F 15/00

(52) U.S. Cl. CPC B66F 15/00
USPC 254/129; 254/120; 254/131

(57) ABSTRACT

A panel lifter comprises: a first arm comprising a panel engaging element; a second arm comprising a foot pedal; and a fulcrum for engaging the ground connected between the panel engaging element and the foot pedal; wherein the panel engaging member is moveable with respect to the foot pedal.

### FIELD OF THE INVENTION

The present invention relates to a panel lifter. In particular the present invention relates to a panel lifter for lifting drywall panels.

### BACKGROUND OF THE INVENTION

With the current population growth in the world today there is great importance on constructing new buildings for a variety of purposes. New construction techniques often require efficient processes for a quicker build time. One such technique is to use drywall (also known as plasterboard) panels in the interior fitting of the building. The drywall panel provides a premade surface for the interior of the building which can be decorated with minimal treatment beforehand. One such use of drywall panels is in the interior layout of the building whereby interior walls are constructed from a lightweight timber frame and the drywall panels are fixed to the timer frame.

Typically the drywall panels are rectangular panels of 2400 mm×1200 mm and weigh over 20 Kg. When fitting the drywall panels they are usually lifting a few centimetres off the ground. Lifting and manoeuvring the large and heavy drywall panels can be difficult especially if the long side of the drywall panel is used vertically.

Panel lifters are known for helping a user lift and move drywall panels. For example U.S. Pat. No. 2,692,753 shows a panel lifting and supporting device. A problem with this panel lifter is that the panel lifter only lifts the panel to a single predetermined height. If the user wants to raise the panel against a wall to a height lower than the set height, the user will have to try and balance the panel on the fulcrum of the panel lifter with their foot. This can be difficult especially if the user is trying the secure the panel at the same time.

### BRIEF SUMMARY OF THE INVENTION

Embodiments of the present invention aim to address the aforementioned problems.

According to an aspect of the present invention there is a panel lifter comprising: a first arm comprising a panel engaging element; a second arm comprising a foot pedal; and a fulcrum for engaging the ground connected between the panel engaging element and the foot pedal; wherein the panel engaging member is moveable with respect to the foot pedal.

The distance between the panel engaging element and the foot pedal can be adjusted. This means that the height that the panel lifter can lift a panel off the ground can be varied. This means that the user can select the desired height to lift the panel and then operate the panel by pressing the foot pedal down until the foot pedal engages the ground. This means the user does not have to balance the panel on the fulcrum against their foot. Furthermore by varying the distances between the panel engaging element, the fulcrum and the foot pedal, the user can vary the mechanical advantage needed to lift a panel.

Preferably the first arm is moveable with respect to the second arm. This means that by moving the first arm with respect to the second arm, the panel engaging element and the foot pedal can be moved with respect to each other. Alternatively, the panel engaging element and/or the foot pedal can be moved with respect to each other and the first and second arms. For example the panel engaging element can be moved to a different position on the first arm.

Preferably the panel lifter comprises an adjustment mechanism for fixedly adjusting the panel engaging element with respect to the foot pedal. The panel lift may comprise a rod for coupling the first and second arms, the first arm comprising a slot for receiving a rod and the second arm comprises a hole for receiving the rod and the rod is slidable within the slot.

Preferably the panel lifter comprises an adjustable handle. Additionally or alternatively the adjustable handle is mounted to the rod. Preferably the adjustable handle is adjustable and engagable with a panel when the panel engaging element engages with the panel. The handle makes the tool convenient to carry and can also be stowed away when not in use. The handle can be adjusted so that it is near the panel engaging element. This means the handle can also provide support for the panel. The handle can be angled differently depending on the relative position of the panel engaging element with respect to the handle.

Preferably the fulcrum is mounted to the second arm.

The first and second arms are detachable from each other. This means that the panel lifter can be disassembled by the user for cleaning and maintenance. Preferably the rod comprises a threaded portion and a threaded fastener mates therewith and the threaded fastener is arranged to clamp the first and second arms together when threaded on the threaded portion. The threaded fastener may be a user adjustable tooless threaded fastener. The user can easily adjust and disassemble the panel lifter without the need of a tool.

Preferably the first arm comprises a chamfered portion underneath the panel engaging portion, the chamfered portion being substantially parallel with the ground. This means the panel lifter is easier to slide underneath the edge of a panel to be lifted.

The panel engaging element may comprises an upright panel stop element mounted adjacent an end portion of the first arm such that the end portion engages with an edge of the panel and upright panel stop engages with a flat surface of the panel. The upright panel stop element and the end portion form an “L” shape to engage the panel.

### BRIEF DESCRIPTION OF THE DRAWINGS

Various other aspects and further embodiments are also described in the following detailed description and in the attached claims with reference to the accompanying drawings, in which:

FIG. 1 shows a perspective view of the panel lifter;

FIG. 2 shows side view of the panel lifter;

FIG. 3 shows a perspective view of a part of the panel lifter;

FIG. 4 shows a schematic side view of panel lifter with the adjustable handle;

FIGS. 5a and 5b show a side view of the panel lifter in different positions.

### DETAILED DESCRIPTION OF THE INVENTION

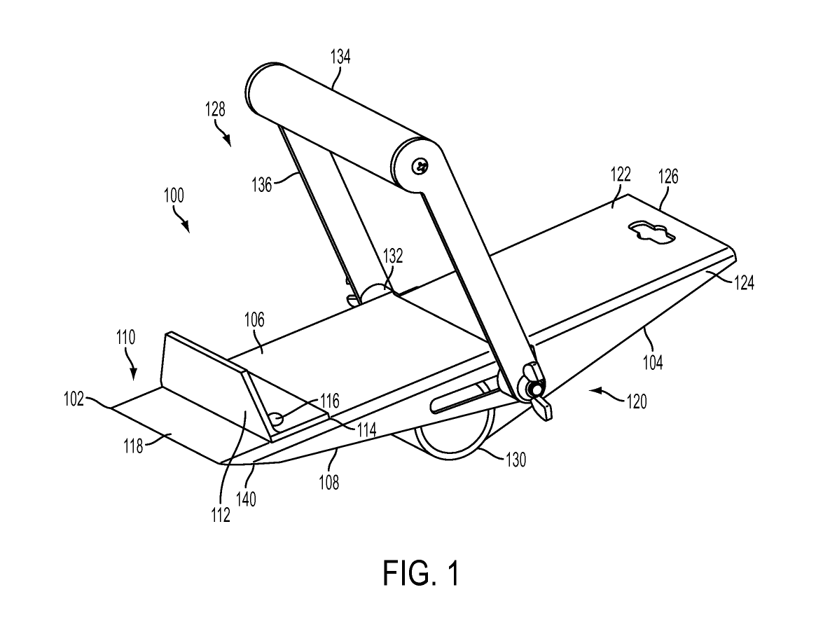

FIG. 1 shows a perspective view of a panel lifter 100. The panel lifter 10 may be used in construction and DIY where various panels are required to be lifted. For example, drywall (also known as plasterboard) is manufactured in panels which are fixed to existing interior walls or an interior timber frame. In some circumstances the panels have to be lifted and manoeuvred during fitting. Typically the panels have a generally flat shape and a thin edge (e.g. some drywall panels have the dimensions 2400 mm×1200 mm×12.5 mm). The panel lifter 10 is configured to lift drywall panels, but can be used with other panel type materials.

The panel lifter 100 comprises a first arm 102. The first arm 102 has a flat top surface 106 and two side wings 108. The first arm 102 is a generally a flat sheet and a portion thereof is folded down to form the side wings 108. The first arm 102 is a hollow wedge shape with the wedge tapering towards an end portion 118 of the first arm. The wedge is thickest in the middle of the panel lifter. The first arm 102 comprises a panel engaging element 110 for engaging a panel to be lifted.

The panel engaging element 110 comprises an upright panel stop 112.

The upright panel stop 112 has an “L” shaped cross section and the base 114 of the upright panel stop 112 is adjacent to the top surface 106. The upright panel stop 112 is fixed to the first arm 102 with one or more rivets 116. The upright panel stop 112 is configured to engage with a flat surface of the panel. The upright panel stop 112 limits or stops the panel from falling back on to the user. The panel engaging element 110 also comprises an end portion 118 of the first arm 102. The wedge shape of the first arm 102 helps define a thin structure at the end portion 118 of the first arm 102. The end portion 118 is configured to slide underneath the edge of a panel to be lifted. The upright panel stop 112 and the end portion 118 of the first arm 102 form an “L” shape. In some embodiments the upright panel stop 112 and the end portion 118 meet at right angles. The “L” shape of the panel engaging element 110 better engages a corner of the panel at a thin edge of the panel.

The side walls 108 of first arm 102 comprise a chamfered portion 140 at the end portion 118. The chamfered portion 140 makes the side walls 108 substantially parallel to the ground when the panel lifter 100 is in the position for sliding the panel engaging portion 110 underneath the panel. This makes the first arm 102 easier to slide underneath the panel because the chamfer stops the first arm 102 digging into the ground.

The first arm 102 is coupled to a second arm 104 with an adjustment mechanism 120. The adjustment mechanism 120 is configured to fixedly adjust the first arm 102 with respect to the second arm 104.

The second arm 104 comprises a flat top surface 122 and two side wings 124. The flat top surface 122 is a foot pedal suitable for receiving a user's foot for operating the panel lifter 100. Similar to the first arm 102, the second arm 104 is constructed from a sheet material and a portion thereof is folded down to form the side wings 124. The second arm 104 comprises a general wedge shape tapering to a thin end portion 126 of the second arm 104. The second arm 104 is slightly smaller than the first arm 104. This means that the second arm 104 sits inside the first arm 102 and the first arm can slide freely past the second arm 104.

A fulcrum 130 is fixedly connected to the second arm 104 at the opposite thick end to the thin end portion 126. The fulcrum 130 comprises a cylinder wherein the second arm 104 is fixed to a portion of the cylinder. The fulcrum 130 engages with the ground and the cylindrical surface aids pivoting of the panel lifter 100 in use as the cylinder rolls over the ground.

Although the fulcrum 130 is fixed as shown in the Figures, in some embodiments (not shown) the fulcrum 130 is mounted to the second arm 104 via a bearing (not shown) and the fulcrum can rotate with respect to the second arm 104. This means that the fulcrum 130 can act as a wheel and the panel lifter 100 can be used to lift and wheel the panel into position.

A handle 128 is coupled to the first and second arms 102, 104. The handle 128 comprises a horizontal bar 134 and two legs 136 for connecting to the panel lifter 100. The horizontal bar 134 comprises a cylindrical gripping portion for easy handling. In some embodiments the handle 128 is adjustable with respect to the first and second arms 102, 104. In other embodiments (not shown) the handle 128 is fixed with respect to the second arm 104. In some embodiments and as shown in the Figures the handle 128 is coupled to the first and second arms 102, 104 with the same adjustment mechanism 120 that coupled the first and second arms 102, 104 together.

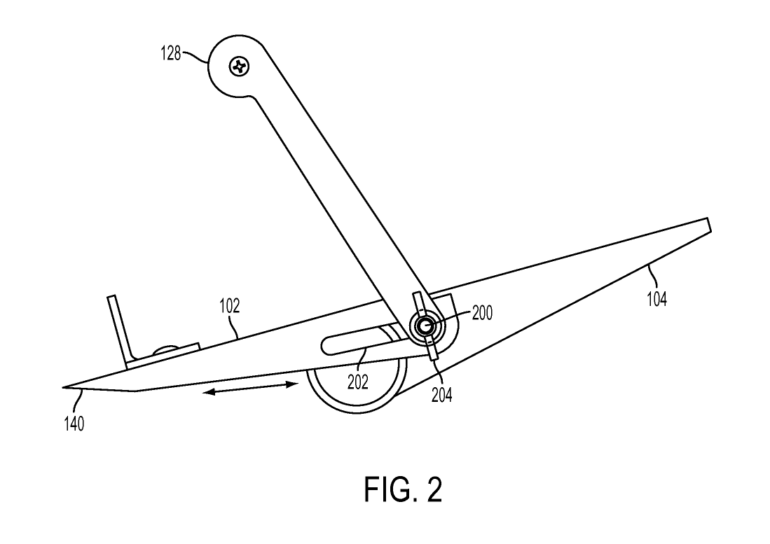

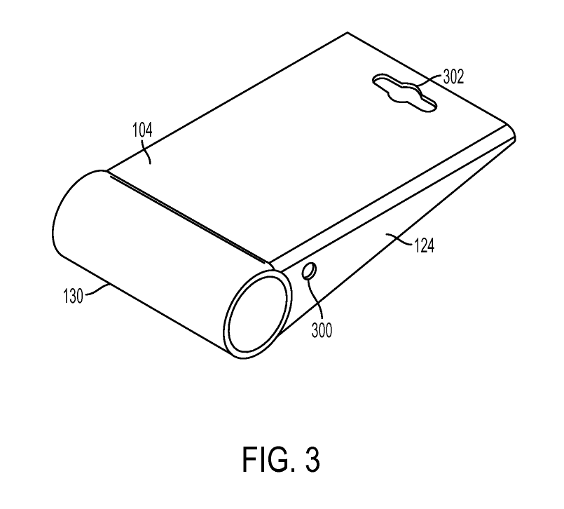

Reference will now be made to FIGS. 2 and 3 to discuss the adjustment mechanism 120 in more detail. FIG. 2 shows a side view of the panel lifter 100 and FIG. 3 shows a perspective view of the second arm 104.

Turning to FIG. 2, a rod 200 couples the first arm 102, the second arm 103 and the handle 128 together. In some embodiments the rod 200 is threaded and a threaded fastener 204 such as a wing nut is threaded on to the rod 200. The wing nut 204 clamps and fixes the position of the first arm 102 with respect to the second arm 104. At the same time the wing nut clamps and fixes the position of the handle 128 with respect to the first arm 102 and second arm 104. The rod 200 protrudes through a linear slot 202 in each of the side walls 108 of the first arm 102.

Briefly turning to FIG. 3, each of the side walls 124 of the second arm 124 comprise a hole 300 for receiving the rod 200. The rod 200 protrudes through the linear slots 202 and the holes 300. Wing nuts 204 are threaded on both ends of the rod. The wing nuts 204 allow the user to tighten and loosen the adjustment mechanism 120 without the need for a tool. In some embodiments the adjustment mechanism 120 can comprise any means suitable for tightening and loosening the first arm 102 to the second arm 104.

In some embodiments the second arm 104 may comprise a hole 302 for hanging the panel lifter 100 on a hook. The hole 302 may be configured for receiving a shop display hook for displaying the panel lifter 100 before sale.

Turning back to FIG. 2, adjustment of the panel lift will now be discussed. When the user wishes to adjust the panel lifting height of the panel lifter, the user loosens the adjustment mechanism 120. The user slackens off the wing nuts 204 and then the first arm 102 will be moveable with respect to the second arm 104. The linear slot 202 restricts the movement of the first arm 102 with respect to the second arm 104 as shown by the arrow in FIG. 2. The rod 200 is slidable within the slot 202 and the first arm 102 may be extended away from the second arm 104 or retracted towards the second arm 104 as needed. Once the user has adjusted the first arm 102 to the required position, the user tightens the wing nuts 204 to clamp the first arm 102 and the second arm 104 in position. Washers 132 are threaded on the rod 200 and are located between the handle 128 and the side wall 108 of the first arm. In some embodiments (not shown) the washers 132 are not used.

When the user wishes to adjust the position of the handle 128 with respect to the first and second arms 102, 104, the user also slackens off the wing nuts 204. In order to move the position of the handle 128, the user does not have to loosen the adjustment mechanism as much because the legs 136 of the handle 128 act as levers for pivoting the handle 128. This means that the user can adjust the position of the handle 128 without disturbing the position of the first and second arms 102, 104.

The handle 128 provides a convenient solution for quickly picking up and moving the panel lifter 100. The adjustable handle 128 means that the handle 128 can be stowed adjacent to the second arm 104 or the first arm 102. which makes storing the panel lifter 102 easier.

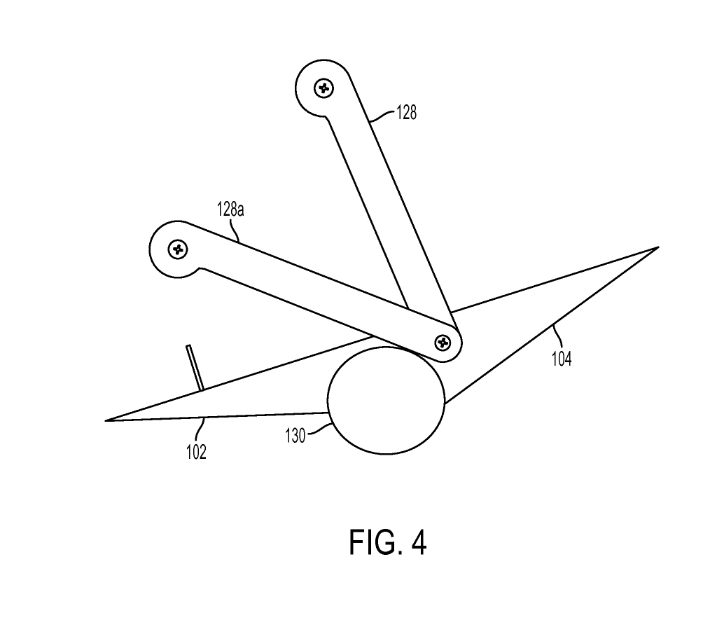

In addition the handle 128 can be adjusted so that the handle 128 engages the panel when the panel lifter 100 is in operation. The handle 128 is configured to be pivotable about the axis of the rod 200. FIG. 4 shows a schematic side view of the panel lifter with the handle 128 shown in two positions. The handle 128 pivots forward so that the handle is adjacent the upright panel stop 112 as shown by handle 128a in FIG. 4. When the handle 128 engages the panel, the panel may be more stable during the lift.

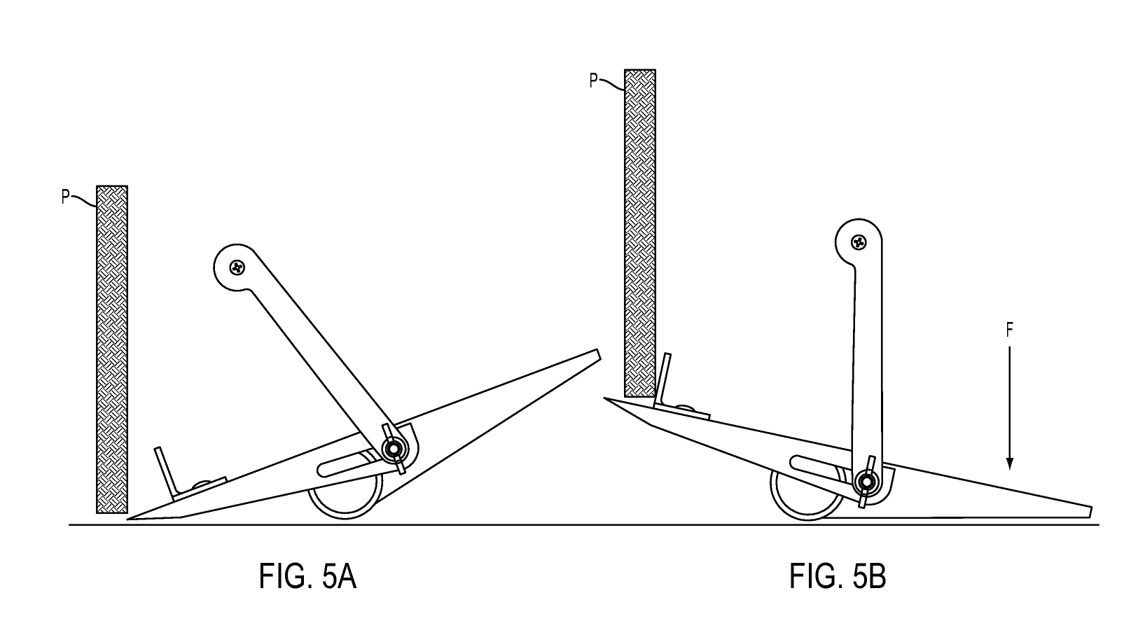

In some embodiments the handle 128 may be configured to adjust the centre of mass of the panel lifter 100. In some embodiments the horizontal bar 134 comprises a material and mass such that when the handle 128 is pivoted adjacent to the upright panel stop 112, the centre of mass of the panel lifter is over the first arm 102 side of the fulcrum 130. This means that the panel lifter 100 falls about the fulcrum 130 so that the panel lifter is automatically in the position for sliding the panel engaging element 110 underneath the panel (e.g. the panel lifter position as shown in FIG. 5a). This means that the user does not have to physically move the panel lifter 100 so that the first arm 102 is adjacent the ground. When the user adjusts the position of the first arm 102 with respect to the second arm 104, the handle 128 can also be adjusted to maintain the centre of mass over the first arm 102 side of the fulcrum 130. For example when the first arm 102 is retracted towards the fulcrum, the centre of mass moves towards the second arm 104, but the handle 128 can be pivoted towards the panel engaging element 110 returning the centre of mass to the first arm 102 side of the fulcrum 130.

Operation of the panel lifter 100 will now be briefly discussed in reference to FIGS. 5a and 5b. FIGS. 5a and 5b show the side views of panel lifter. When the user wants to lift a panel, the user orientates the panel lifter 100 into a position for sliding the panel engaging element 110 underneath an edge of the panel P. Once the panel engaging element 110 has engaged the panel P, the user pushes down on the foot pedal 122 as shown in FIG. 5b. Pushing down on the foot pedal 122 pivots the first arm 102 and the panel about the fulcrum 130 and the first arm 102 lifts the panel P.

In some embodiments (not shown) the upright panel stop 112 is moveable with respect to the first arm 102. The first arm 102 may comprise slots (not shown) in the top surface 106 and the upright panel stop 112 has a threaded projection for protruding through the slots. The upright panel stop 112 is fixed in position with a threaded fastener such as a wing nut (not shown). The wing nut clamps the upright panel stop 112 to the first arm 102 when the wing nut us threaded on the projection.

Embodiments of the present invention have been discussed with particular reference to the examples illustrated. However it will be appreciated that variations and modifications may be made to the examples described within the scope of the invention.

1. A panel lifter comprising:
a first arm comprising a panel engaging element;
a second arm comprising a foot pedal; and
a fulcrum for engaging the ground connected between the panel engaging element and the foot pedal;
wherein the panel engaging member is moveable with respect to the foot pedal.

2. A panel lifter according to claim 1 wherein the first arm is moveable with respect to the second arm.

3. A panel lifter according to claim 1 wherein the panel lifter comprises an adjustment mechanism for fixedly adjusting the panel engaging element with respect to the foot pedal.

4. A panel lifter according to claim 3 wherein the panel lift comprises a rod for coupling the first and second arms, the first arm comprising a slot for receiving a rod and the second arm comprises a hole for receiving the rod and the rod is slidable within the slot.

5. A panel lifter according to claim 1 wherein the panel lifter comprises an adjustable handle.

6. A panel lifter according to claim 4 wherein the panel lifter comprises an adjustable handle mounted to the rod.

7. A panel lifter according to claim 5 wherein the adjustable handle is adjustable and engagable with a panel when the panel engaging element engages with the panel.

8. A panel lifter according to claim 1 wherein the fulcrum is mounted to the second arm.

9. A panel lifter according to claim 1 wherein the first and second arms are detachable from each other.

10. A panel lifter according to claim 4 wherein the rod comprises a threaded portion and a threaded fastener mates therewith and the threaded fastener is arranged to clamp the first and second arms together when threaded on the threaded portion.

11. A panel lifter according to claim 10 wherein the threaded fastener is a user adjustable tooless threaded fastener,

12. A panel lifter according to claim 1 wherein the first arm comprises a chamfered portion underneath the panel engaging portion, the chamfered portion being substantially parallel with the ground.

13. A panel lifter according to claim 1 wherein the panel engaging element comprises an upright panel stop element mounted adjacent an end portion of the first arm such that the end portion engages with an edge of the panel and upright panel stop engages with a flat surface of the panel.

14. A panel lifter according to claim 1 wherein the fulcrum is configured to rotate with respect to the first arm and or the second arm.
